(19) United States
(12) Patent Application Publication
(10) Pub. No.: US 2011/0031828 A1
(43) Pub. Date: Feb. 10, 2011

(54) E-Z tent trailler lift model #2B

(76) Inventor: Delmer Wesley Forester, Spokane Valley, WA (US)

Correspondence Address: DELMER W. FORESTER, 13520 EAST RICH AVENUE #4, SPOKANE VALLEY, WA, 99216, US

(21) Appl. No.: 12/592,842

(22) Filed: Mar. 1, 2010

Related U.S. Application Data
(60) Provisional application No. 61/273,777, filed on Aug. 10, 2009.

(51) Int. Cl. H02K 7/10

(52) U.S. Cl. 310/83

(57) ABSTRACT

The E-Z Tent Trailer Lift Model #2B (hereafter referred to as the E-Z Lift in this document) consists of a roller chain and sprocket-reduction drive, operated by a reversible 12V DC gear head motor, controlled by a two-way switch with an interior cut-off switch to prevent tampering. Powered by on-board or towing vehicle 12V batteries. The 12V gear head motor is reversible to provide for clockwise action to raise the tent portion of the pop-up trailer and counter clockwise to lower it.

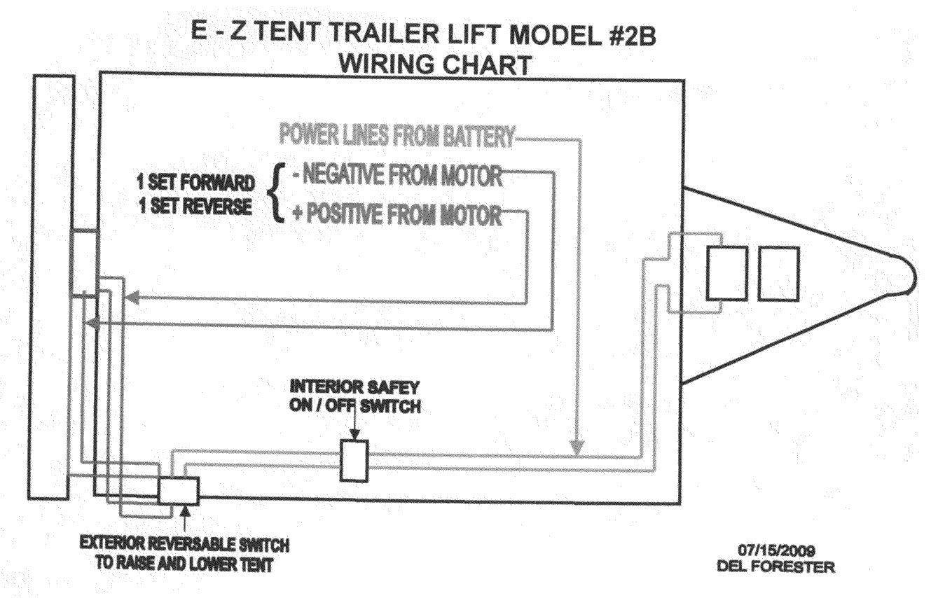

### PARTS LIST

A. 1 EA—220 RPM DC Reversible Gear Head Motor

B. 1 EA—Mounting Base Plate

C. 1 EA—Motor Mount

D. 1 EA—Stabilizing Bracket

E. 1 EA—40 Pitch 9″ 48 Tooth Sprocket with 1⅛″ Bore

F. 1 EA—40 Pitch 3″ 16 Tooth Sprocket with ½″ Bore

G. 1 EA—40 Pitch Roller Chain—49″ Long

H. 1 EA—On/Off Toggle Switch w/Cover Plate

I. 1 EA—Two Way Toggle Switch w/ Plastic Waterproof Cover

J. 8 FT—#12 Double Wire

K. 8 EA—#6 Wire Tips

L. 10 FT—#10 Double Wire

M. 2 EA—#2 Wire Tips

N. 6 EA—Machine Bolts w/Flat Washers

O. 4 FT—½″ Plastic Conduit

### ASSEMBLY

Initially, determine the location and positioning for the 220 RPM 12V Motor (Part A.) in relationship to the crankshaft Motor for the tent. Drill holes to accommodate the bolts and stabilize on the Mounting Brackets (Parts B. & C. & N)

Mount motor with respect for positioning of sprockets on drive shaft and the tent crank shaft. The larger DRIVEN sprocket (Part E.) is positioned on the hand crank shaft and the smaller Drive sprocket (Part F.) is positioned on the Motor drive shaft.

Align both Sprockets (Parts E. & F.) properly and determine exact length of Roller Chain (Part G.) needed and install the chain on the sprockets.

The Interior ON/OFF (safety cutoff) Switch (H.) should be installed on cabinet just inside of the trailer door for accessibility when tent is down.

Next install the Exterior Two-way Switch components (Part I.) In appropriate position. You will need to drill circle hole in exterior shell of unit, and use the waterproof cover to install the Two-way Switch. When the Toggle is flipped to the upward position it will provide clockwise rotation of the shafts to raise the tent of the trailer. Down position on the two-way switch will provide counter-clockwise rotation which will lower the tent.

DC power is provided by on board 12 V Batteries. Run both positive and negative wires (using Parts J. and K.) directly from battery to the ON/OFF (cutoff) switch. Splice the ON/OFF Switch (Part H.) into the negative wire. Another set of positive and negative wires are connected to the terminals on the Exterior Two-way Switch and run to the Motor in clockwise rotation. Run one more set of positive and negative wires (Parts L.& M.) (reversing positive and negative positions) from the other two terminals on the Exterior Two-way Switch to the remaining terminals on the Motor (again, reversing the positive & negative positions).** **Please refer to schematic enclosed—Drawings page 3

Using (Part O.) (Flexible) Plastic Conduit, cover exterior wires.

### SUMMERY

The E-Z Lift can be installed on the back bumper or front yolk of the tent trailer, depending on where the crank receptacle is located. The 12-volt batteries on board the trailer power the E-Z Lift, although it is possible to configure the wiring to adapt to the towing vehicle as well. In the event that batteries might lose their charge, the manual crank can still be operated as back up if necessary. This unit can by installed at time of manufacture or as a retrofit accessory.

I claim:

1. Reversible DC Motor and gear assembly to raise and lower tent portion of tent trailers.
